(19) United States
(12) Patent Application Publication
(10) Pub. No.: US 2015/0368106 A1
(43) Pub. Date: Dec. 24, 2015

(54) METHOD FOR MAKING CARBON NANOTUBE WIRE STRUCTURE

(71) Applicants: TSINGHUA UNIVERSITY, Beijing (CN); HON HAI PRECISION INDUSTRY CO., LTD., New Taipei (TW)

(72) Inventors: KAI LIU, Beijing (CN); KAI-LI JIANG, Beijing (CN); SHOU-SHAN FAN, Beijing (CN)

(21) Appl. No.: 14/836,971

(22) Filed: Aug. 27, 2015

Related U.S. Application Data
(62) Division of application No. 12/978,548, filed on Dec. 25, 2010.

(30) Foreign Application Priority Data
Aug. 23, 2010 (CN) 201010259961.6

(51) Int. Cl. C01B 31/02

(52) U.S. Cl. CPC C01B 31/0253

(57) ABSTRACT

The present disclosure provides a method for making the carbon nanotube wire structure. At least one carbon nanotube structure is provided. A flexible core having an elongation at break greater than 5% is provided. The at least one carbon nanotube structure is wrapped around the flexible core along a longitude direction of the flexible core to form a carbon nanotube layer.

### RELATED APPLICATIONS

This application is a continuation of U.S. patent application Ser. No. 12/978,548, filed on Dec. 25, 2010, “CARBON NANOTUBE WIRE STRUCTURE AND METHOD FOR MAKING THE SAME”. The disclosures of the above-identified applications are incorporated herein by reference.

### BACKGROUND

1. Technical Field

The present disclosure relates to carbon nanotube wire structures and methods for making the same and, particularly, to a carbon nanotube wire structure and a method for making the same.

2. Discussion of Related Art

Carbon nanotubes are composed of a plurality of coaxial cylinders of graphite sheets. Carbon nanotubes have received a great deal of interest since the early 1990s. Carbon nanotubes have interesting and potentially useful electrical and mechanical properties. Due to these and other properties, carbon nanotubes have become a significant focus of research and development for use in electron emitting devices, sensors, transistors, and other devices.

Generally, carbon nanotubes prepared by conventional methods are in particle or powder form. The particle or powder-shaped carbon nanotubes limit the applications of the carbon nanotubes. Thus, preparation of macro-scale carbon nanotube structures has attracted attention.

A carbon nanotube wire structure is one macro-scale carbon nanotube structure. The carbon nanotube wire structure includes a number of carbon nanotubes, and qualifies as a novel potential material which can replace carbon nanofibers, graphite nanofibers, and fiberglass. The carbon nanotube wire structure can be used in electromagnetic shield cables, printed circuit boards, special garments, and so on.

A typical example is shown and discussed in U.S. Publication. No. 20070166223A, entitled, “METHOD FOR MAKING CARBON NANOTUBE YARN,” published to Fan et al. on Jul. 19, 2007. This patent discloses a carbon nanotube yarn. The method for making the yarn includes providing a super-aligned carbon nanotube array, drawing a carbon nanotube film from the carbon nanotube array, and treating the carbon nanotube film with an organic solvent to form a carbon nanotube yarn.

However, a diameter of the yarn made by the method is restricted by a scale of the carbon nanotube array. The carbon nanotube array is usually grown on a silicon substrate. A large silicon substrate is difficult to produce using the present silicon technology. Therefore, it is difficult to acquire a large area of the carbon nanotube array. Thus, the yarn twisted by the pre-primary assembly has a small diameter and the tensile strength and strain of the yarn is inferior, thereby limiting its application.

What is needed, therefore, is a carbon nanotube wire structure with a large diameter, superior tensile strength, and superior strain, and a method for making the same.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of one embodiment of a carbon nanotube wire structure.

FIG. 2 is a schematic, cross-sectional view, taken along a line II-II of FIG. 1.

FIG. 3 is a schematic view of another embodiment of a carbon nanotube wire structure.

FIG. 4 is a schematic, cross-sectional view, taken along a line IV-IV of FIG. 3.

FIG. 5 is a schematic view of one embodiment of a carbon nanotube wire structure.

FIG. 6 is a schematic, cross-sectional view, taken along a line VI-VI of FIG. 5.

FIG. 7 is a schematic view of one embodiment of a method for making a carbon nanotube wire structure of FIG. 1.

FIG. 8 is a schematic view of one embodiment of a method for making a carbon nanotube structure, which is used in the method of FIG. 7.

FIG. 9 is a Scanning Electron Microscope image (SEM) of a drawn carbon nanotube film used in the method of FIG. 7.

FIG. 10 is an SEM image of a carbon nanotube wire used in the method of FIG. 7.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

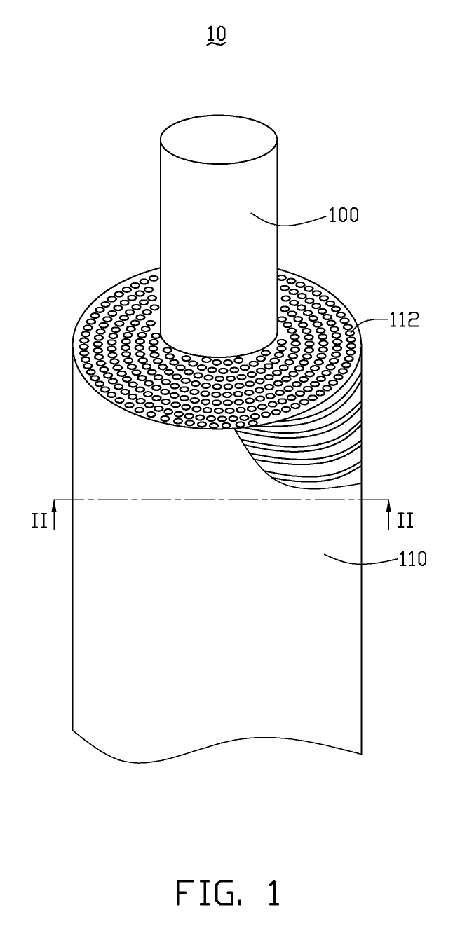

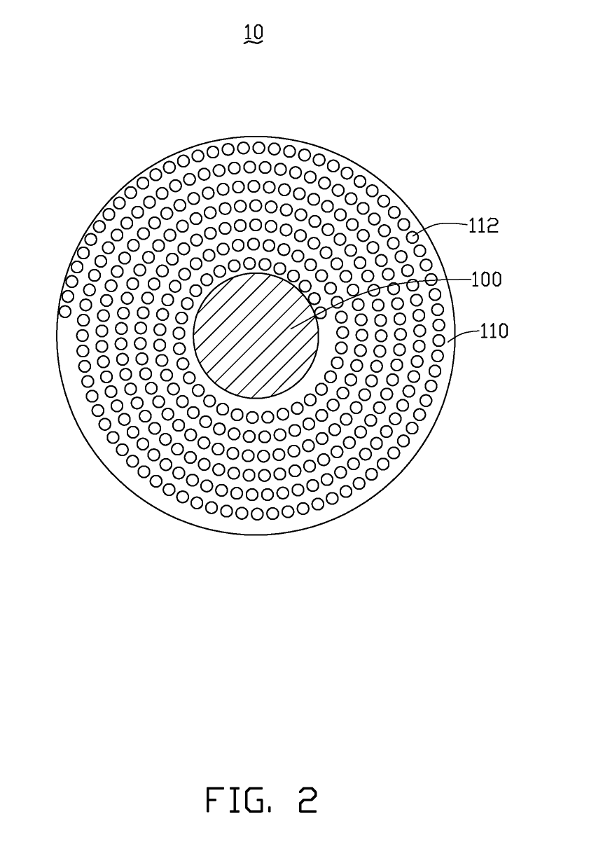

Referring to FIG. 1 and FIG. 2, one embodiment of a carbon nanotube wire structure 10 includes a flexible core 100 and a carbon nanotube layer 110. The flexible core 100 and the carbon nanotube layer 110 are coaxial. The carbon nanotube wire structure 10 is a linear structure. The carbon nanotube layer 110 surrounds the flexible core 100, and adheres on an outer surface of the flexible core 100. The carbon nanotube layer 110 combines with the flexible core 100 to form a single structure.

The flexible core 100 is a linear structure. The flexible core 100 can be natural fibers, such as spider silk or silk of the silkworm. The flexible core 100 can be synthetic fibers, such as polyvinyl alcohol fiber (PVA fiber) or polybenzoxazole (PBO) fiber. The flexible core 100 has a tensile strength greater than 1 Gpa. The flexible core 100 has an elongation at break greater than 5%. The flexible core 100 has a diameter in a range from about 400 nanometers to about 10 micrometers. In one embodiment, the flexible core 100 is spider silk with a diameter in a range from 4 micrometers to about 10 micrometers. Spider silk has a tensile strength greater than 5 Gpa. Spider silk has an elongation at break greater than 15%.

The carbon nanotube layer 110 can be made of a plurality of carbon nanotubes 112 connected with each other by van der Waals attractive forces. The carbon nanotube layer 110 wraps around the flexible core 100. The carbon nanotube layer 110 and the flexible core 100 extend along a lengthwise direction of the carbon nanotube wire structure 10. The carbon nanotubes 112 in the carbon nanotube layer 110 are joined end-to-end and oriented along the lengthwise direction of the carbon nanotube wire structure 10 in a spiral manner. The carbon nanotube layer 110 has a thickness in a range from about 500 nanometers to about 10 micrometers. In one embodiment, the carbon nanotube layer 110 consists of a plurality of carbon nanotubes 112. The carbon nanotubes 112 are connected end to end and surround the flexible core 100 in a helix manner.

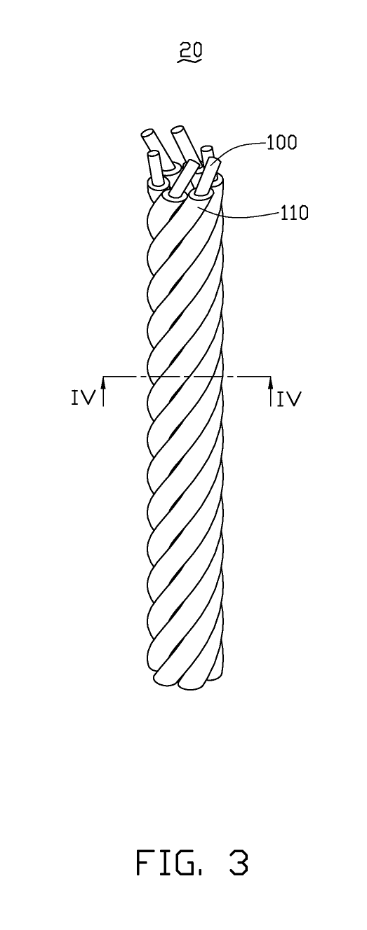

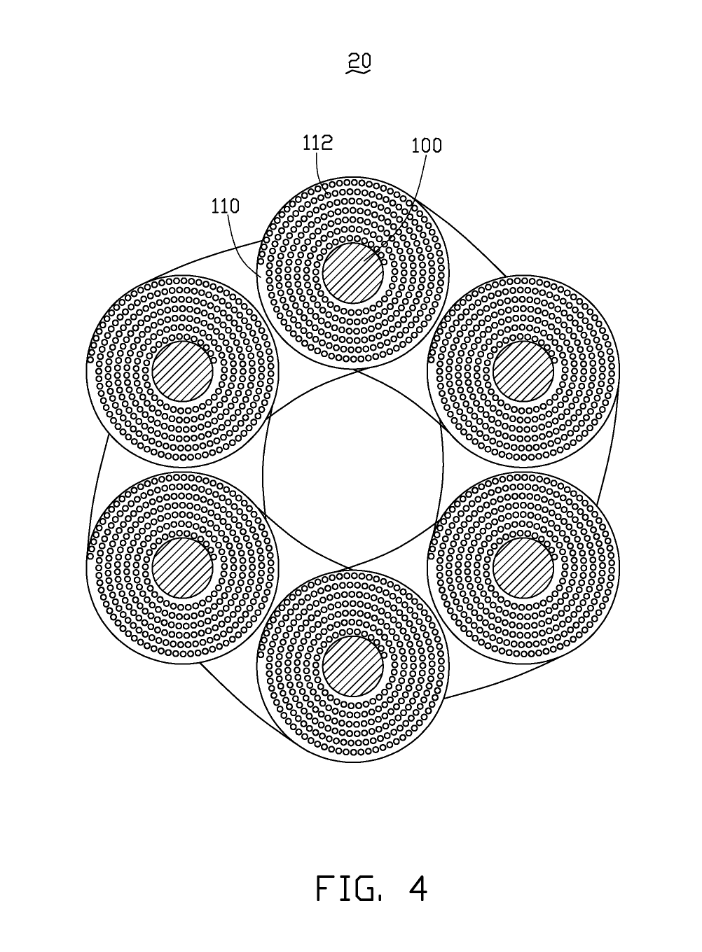

Referring to FIG. 3 and FIG. 4, one embodiment of a carbon nanotube wire structure 20 includes a plurality of flexible cores 100 and a plurality of carbon nanotube layers 110. Each one of the carbon nanotube layers 110 wraps one of the flexible cores 100, and includes a plurality of carbon nanotubes 112. The carbon nanotubes 112 of each of the carbon nanotube layers 110 are joined end-to-end and oriented along the lengthwise direction of the corresponding flexible core 100 in a spiral manner. The flexible cores 100 are braided together and spaced from each other by the carbon nanotube layers 110.

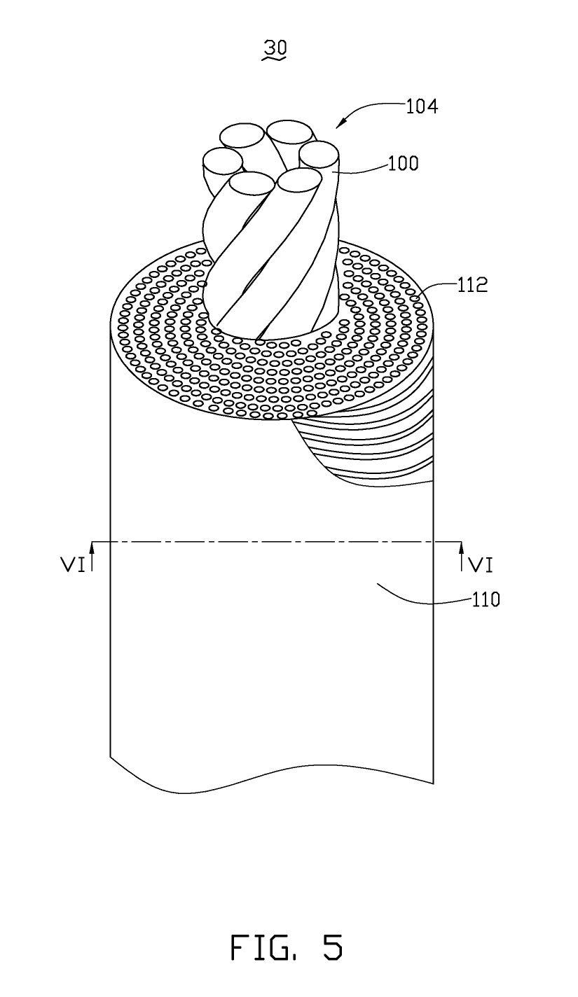

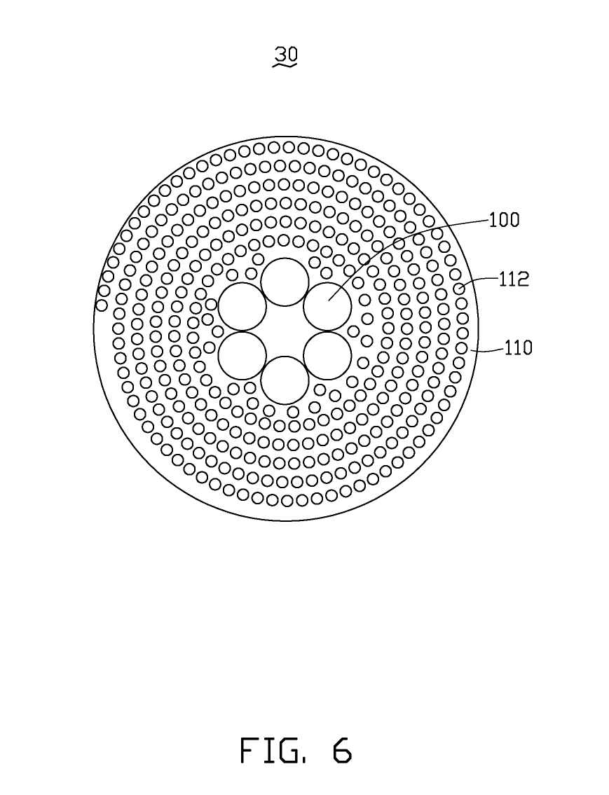

Referring to FIG. 5 and FIG. 6, one embodiment of a carbon nanotube wire structure 30 includes a plurality of flexible cores 100 and a carbon nanotube layer 110. The flexible cores 100 are twisted and braided together to form a single flexible core structure 104. The carbon nanotube layer 110 wraps around the single flexible core structure 104. The carbon nanotubes 112 of the carbon nanotube layer 110 are joined end-to-end and oriented along the lengthwise direction of the single flexible core structure 104 in a spiral manner Because the carbon nanotube wire structure 30 includes a plurality of flexible cores 100, the carbon nanotube wire structure 30 has good tensile strength and strain.

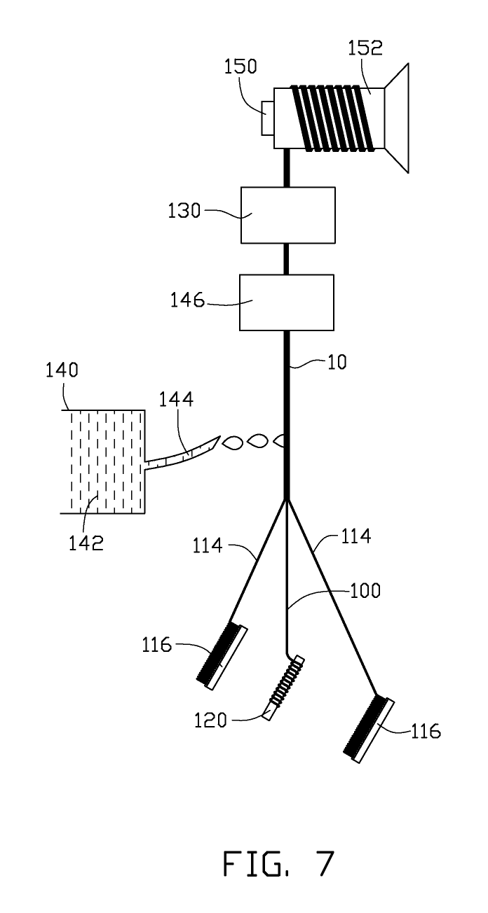

Referring to FIG. 7, one embodiment of a method for making the carbon nanotube wire structure 10 includes:

(S1) providing at least one carbon nanotube structure 114;

(S2) providing a flexible core 100; and

(S3) wrapping the at least one carbon nanotube structure 114 around the flexible core 100 along a longitude direction of the flexible core 100;

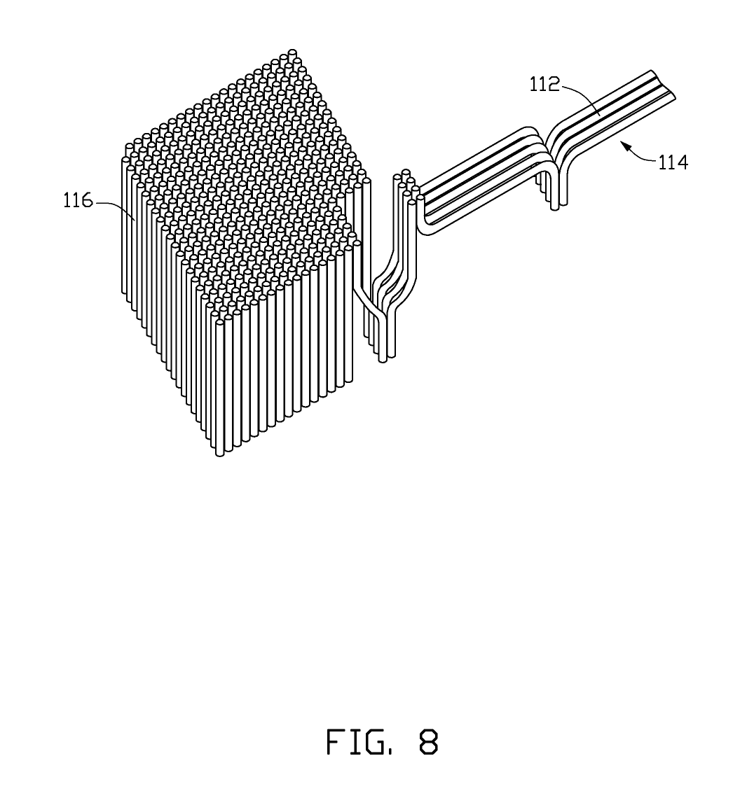

In step (S1), referring to FIG. 8, the at least one carbon nanotube structure 114 can be drawn from a carbon nanotube array 116. The carbon nanotubes 112 connect with each other by van der Waals attractive forces. The at least one carbon nanotube structure 114 can be a carbon nanotube film or a carbon nanotube wire, depending on the width of the carbon nanotube structure 114. The method for making the at least one carbon nanotube structure 114 includes:

(S10) providing a carbon nanotube array 116 (e.g. a super-aligned carbon nanotube array); and

(S11) pulling out the carbon nanotube structure 114 from the carbon nanotube array 116 by using a tool (e.g., adhesive tape, pliers, tweezers, or another tool allowing multiple carbon nanotubes to be gripped and pulled simultaneously).

It is to be understood that a plurality of carbon nanotube arrays 116 can be provided in step (S10) according to application. A plurality of carbon nanotube structures 114 can be pulled out from the plurality of carbon nanotube arrays 116.

In step (S10), a super-aligned carbon nanotube array 116 can be provided and formed by the following sub-steps:

(S101) providing a substantially flat and smooth substrate;

(S102) forming a catalyst layer on the substrate;

(S103) annealing the substrate with the catalyst layer in air at a temperature ranging from about 700° C. to about 900° C. for about 30 to about 90 minutes;

(S104) heating the substrate with the catalyst layer to a temperature ranging from about 500° C. to about 740° C. in a furnace with a protective gas in the furnace; and

(S105) supplying a carbon source gas to the furnace for about 5 minutes to about 30 minutes and growing the super-aligned carbon nanotube array 116 on the substrate.

In step (S101), the substrate can be a P-type silicon wafer, an N-type silicon wafer, or a silicon wafer with a film of silicon dioxide thereon. In the present embodiment, a 4-inch P-type silicon wafer is used as the substrate.

In step (S102), the catalyst can be made of iron (Fe), cobalt (Co), nickel (Ni), or any alloy comprising of iron (Fe), cobalt (Co), and nickel (Ni).

In step (S104), the protective gas can be made up of at least one of nitrogen (N₂), ammonia (NH₃), and a noble gas.

In step (S105), the carbon source gas can be a hydrocarbon gas, such as ethylene (C₂H₄), methane (CH₄), acetylene (C₂H₂), ethane (C₂H₆), or any combination thereof.

The super-aligned carbon nanotube array 116 can be approximately 200 microns to approximately 400 microns in height and include a plurality of carbon nanotubes approximately parallel to each other and approximately perpendicular to the substrate. The carbon nanotubes in the carbon nanotube array 116 can be single-walled carbon nanotubes, double-walled carbon nanotubes, or multi-walled carbon nanotubes. The diameters of the single-walled carbon nanotubes range from about 0.5 nanometers to about 10 nanometers. The diameters of the double-walled carbon nanotubes range from about 1 nanometer to about 50 nanometers. The diameters of the multi-walled carbon nanotubes range from about 1.5 nanometers to about 50 nanometers.

The super-aligned carbon nanotube array 116 formed under the above conditions is essentially free of impurities such as carbonaceous or residual catalyst particles. The carbon nanotubes in the super-aligned carbon nanotube array 116 are closely packed together by van der Waals attractive force.

In step (S11), the at least one carbon nanotube structure 114 can be formed by the following sub-steps:

(S111) selecting a plurality of carbon nanotube segments having a predetermined width from the carbon nanotube array 116; and

(S112) pulling the carbon nanotube segments at an even/uniform speed to achieve a uniform carbon nanotube structure 114.

In step (S111), the carbon nanotube segments having a predetermined width can be selected by using a tool, such as an adhesive tape to contact the carbon nanotube array 116. Each carbon nanotube segment includes a plurality of carbon nanotubes substantially parallel to each other. In step (S112), the pulling direction is arbitrary (e.g., substantially perpendicular to the growing direction of the carbon nanotube array 116).

More specifically, during step (S112), because the initial carbon nanotube segments are drawn out, other carbon nanotube segments are also drawn out end-to-end due to the van der Waals attractive force between ends of adjacent segments. This process of drawing ensures that a continuous uniform carbon nanotube structure 114 having a predetermined width can be formed.

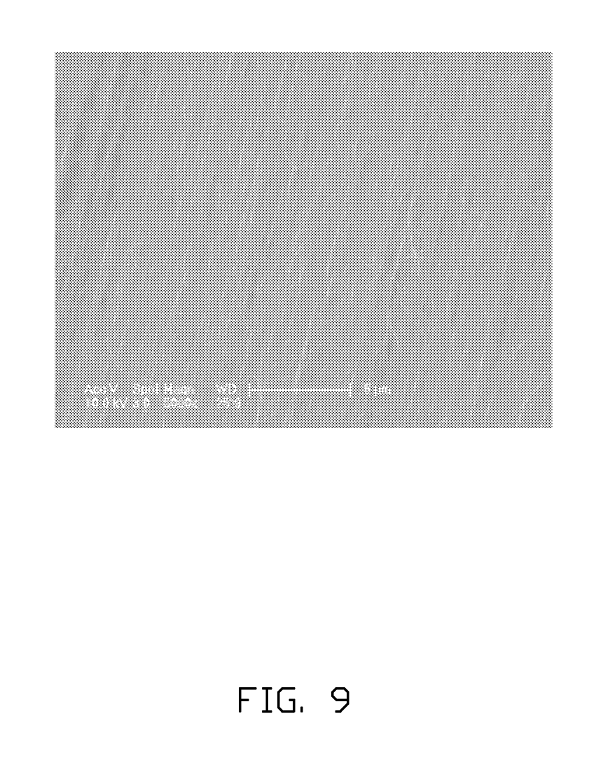

Referring to FIG. 9, in one embodiment, the at least one carbon nanotube structure 114 is a carbon nanotube film including a plurality of carbon nanotubes joined end-to-end. The carbon nanotubes in the carbon nanotube film are all substantially parallel to the pulling/drawing direction of the carbon nanotube film, and the carbon nanotube film produced in such manner can be selectively formed to have a predetermined width. The carbon nanotube film formed by the pulling/drawing method has superior uniformity of thickness and conductivity over a typically disordered carbon nanotube film. Furthermore, the pulling/drawing method is simple, fast, and suitable for industrial applications.

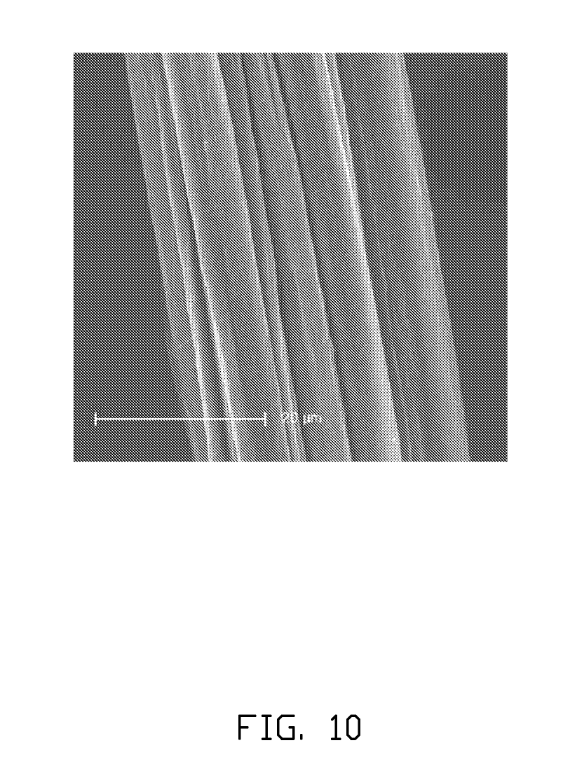

Referring to FIG. 10, in another embodiment, the at least one carbon nanotube structure 114 is a carbon nanotube wire. The carbon nanotube wire includes a plurality of carbon nanotubes joined end to end by the van der Waals attractive force therebetween along an extended direction of the carbon nanotube wire. The carbon nanotubes are organized into a free-standing carbon nanotube wire.

In step (S2), the flexible core 100 can be provided by a supply device 120. The flexible core 100 can be drawn from the supply device 120 by a rotating roller 130. In one embodiment, the flexible core 100 is spider silk having a diameter in a range from about 5 micrometers to about 10 micrometers. Spider silk has a tensile strength greater than 5 Gpa, and an elongation at break greater than 15%.

Referring to FIG. 7, in step (S3), according to one embodiment, the at least one carbon nanotube structure 114 and the flexible core 100 are twisted together by a mechanical force to form the carbon nanotube wire structure 10. The at least one carbon nanotube structure 114 wraps on the flexible core 100 along the longitudinal direction of the flexible core 100 in a helix manner. The flexible core 100 can be fixed at the rotating roller 130. The rotating roller 130 can be rotated clockwise or counterclockwise. In one embodiment, during rotation, each of the carbon nanotube structures 114 is successively drawn from each of the plurality of carbon nanotube arrays 116. As the flexible core 100 is drawn from the supply device 120, one end of each of the carbon nanotube structures 114 is adhered on the outer surface of the flexible core 100. The flexible core 100 is twisted clockwise or counterclockwise into the carbon nanotube wire structure 10 by a mechanical force by the rotating roller 130. The carbon nanotube structure 114 is twisted around the flexible core 100 and wrapped on the outer surface of the flexible core 100. The carbon nanotube structures 114 can adhere on the outer surface of the flexible core 100 to each other to form the carbon nanotube layer 110 because each of the carbon nanotube structures 114 is adhesive in nature. A continuous process of making the carbon nanotube wire structure 10 can be conducted.

To increase the density of the carbon nanotube layer 110 of the carbon nanotube wire structure 10, the carbon nanotube layer 110 can be treated with a volatile organic solvent 142. An entire surface of the carbon nanotube layer 110 can be soaked with the organic solvent 142. The organic solvent 142 can also be dropped on a surface of the carbon nanotube layer 110 by a dropper 140. In one embodiment, the dropper 140 is positioned above the surface of the carbon nanotube layer 110. The dropper 140 includes an opening 144 in a bottom thereof. The organic solvent 142 can be dropped out of the dropper 140 from the opening 144, drop by drop. The organic solvent 142 can be any volatile fluid, such as ethanol, methanol, acetone, dichloroethane, or chloroform. The carbon nanotube layer 110 of the carbon nanotube wire structure 10 will have a low friction coefficient after being treated by the organic solvent.

In one embodiment, the organic solvent 142 is ethanol. After being soaked by the organic solvent 142, the carbon nanotube layer 110 can be tightly shrunk under a surface tension of the organic solvent. The carbon nanotube layer 110 is tightly combined with the flexible core 100 after being treated by the organic solvent 142. The carbon nanotube layer 110 treated by the organic solvent 142 includes a plurality of successively oriented carbon nanotubes joined end to end by van der Waals attractive force, and the carbon nanotubes are aligned around the axis of the carbon nanotube wire structure 10 like a helix. It is difficult to discern the individual carbon nanotubes in the carbon nanotube wire structure 10, even when taking a cross section of the organic solvent treated carbon nanotube wire structure 10.

Furthermore, the carbon nanotube wire structure 10 can be dried after being treated with the organic solvent 142. In the embodiment shown in FIG. 7, the carbon nanotube wire structure 10 passes through a drying device 146. The temperature of the drying device 146 can be in a range from about 80 degrees centigrade to about 100 degrees centigrade, thus the organic solvent 142 in the carbon nanotube layer 110 of the carbon nanotube wire structure 10 can volatilize quickly. The carbon nanotubes in the carbon nanotube wire structure 10 are then arranged more closely. In another embodiment, the carbon nanotube wire structure 10 is dried with a blow dryer.

A diameter of the carbon nanotube wire structure 10 is related to the number and size of the carbon nanotube array 116. The diameter of the carbon nanotube wire structure 10 can be any diameter, such as about 1 micron or more than 50 microns. In one embodiment, the diameter of the carbon nanotube wire structure 10 is about 130 microns.

The carbon nanotube wire structure is made up of the flexible core and the carbon nanotube layer surrounding the flexible core. The carbon nanotube wire structure in the present disclosure has a good tensile strength and elongation at break, and can be used in the field of body armor.

It is to be understood that the above-described embodiment is intended to illustrate rather than limit the disclosure. Variations may be made to the embodiment without departing from the spirit of the disclosure as claimed. The above-described embodiments are intended to illustrate the scope of the disclosure and not restricted to the scope of the disclosure.

It is also to be understood that the above description and the claims drawn to a method may include some indication in reference to certain steps. However, the indication used is only to be viewed for identification purposes and not as a suggestion as to an order for the steps.

What is claimed is:

1. A method for making a carbon nanotube wire structure, comprising steps of:
(S1) providing at least one carbon nanotube structure;
(S2) providing a flexible core having an elongation at break greater than 5%; and
(S3) wrapping the at least one carbon nanotube structure around the flexible core along a longitude direction of the flexible core to form a carbon nanotube layer.

2. The method of claim 1, wherein in step (S1), a process for making the at least one carbon nanotube structure comprises the steps of:
providing at least one carbon nanotube array and at least one drawing tool;
contacting a plurality of carbon nanotubes, of the at least one carbon nanotube array, to the at least one drawing tool; and
drawing the plurality of carbon nanotubes along a direction to form the at least one carbon nanotube structure.

3. The method of claim 1, wherein the flexible core is spider silk.

4. The method of claim 1, wherein the step (S3) comprises: adhering one end of the at least one carbon nanotube structure on the flexible core, and twisting the flexible core by a mechanical force to wrap the at least one carbon nanotube structure around the flexible core to form the carbon nanotube wire structure.

5. The method of claim 4, further comprising a step (S4) of treating the carbon nanotube layer with an organic solvent after the flexible core is twisted.

6. The method of claim 5, wherein the at least one of carbon nanotube structure is a carbon nanotube film comprising a plurality of carbon nanotubes joined end-to-end.

7. The method of claim 6, wherein the plurality of carbon nanotubes in the carbon nanotube layer shrink together to increase a density of the carbon nanotube layer after being treated with the organic solvent.

8. A method for making a carbon nanotube wire structure, comprising steps of:
(S1) providing a carbon nanotube film comprising a plurality of carbon nanotubes joined end to end by van der Waals attractive force along a same direction;
(S2) providing a spider silk having a diameter in a range from about 5 micrometers to about 10 micrometer; and
(S3) wrapping the carbon nanotube film around the spider silk along a longitude direction of the spider silk to form a carbon nanotube layer.

9. The method of claim 8, wherein in step (Si), the carbon nanotube film is obtained by:
providing a carbon nanotube array and a drawing tool;
contacting a plurality of carbon nanotubes, of the carbon nanotube array, to the drawing tool; and
drawing the plurality of carbon nanotubes along a fixed direction to form the carbon nanotube film.

10. The method of claim 9, wherein the carbon nanotube array is a super-aligned carbon nanotube array provided by steps of:
providing a substantially flat and smooth substrate;
forming a catalyst layer on the substrate;
annealing the substrate with the catalyst layer in air at a temperature ranging from about 700° C. to about 900° C. for about 30 to about 90 minutes;
heating the substrate with the catalyst layer ranging from about 500° C. to about 740° C. in a furnace with a protective gas in the furnace; and
supplying a carbon source gas to the furnace for about 5 minutes to about 30 minutes and growing the super-aligned carbon nanotube array on the substrate.

11. The method of claim 8, wherein in step (S3), the carbon nanotube film wraps on the spider silk along the longitude direction of the spider silk in a helix manner.

12. The method of claim 11, wherein in step (S3), the plurality of carbon nanotubes of the carbon nanotube film are aligned around an axis of the carbon nanotube wire structure in a helix way.

13. The method of claim 8, wherein in step (S3), an organic solvent is dropped on a surface of the carbon nanotube layer by a dropper.

14. The method of claim 13, wherein the organic solvent is ethanol, methanol, acetone, dichloroethane, or chloroform.

15. A method for making a carbon nanotube wire structure, comprising steps of:
(S1) providing at least one carbon nanotube wire comprising a plurality of carbon nanotubes joined end to end along a same direction;
(S2) providing a flexible core having an elongation at break greater than 5%; and
(S3) adhering one end of the at least one carbon nanotube wire on the flexible core, and twisting the flexible core by a mechanical force to wrap the at least one carbon nanotube wire around the flexible core to form the carbon nanotube wire structure.

16. The method of claim 15, wherein the flexible core is a spider silk having a diameter in a range from about 5 micrometers to about 10 micrometer.

17. The method of claim 15, wherein a carbon nanotube layer is formed around the flexible core by the at least one carbon nanotube wire, and carbon nanotubes in the carbon nanotube layer are joined end-to-end and oriented along an lengthwise direction of the carbon nanotube wire structure in a spiral manner.
